(19) United States
(12) Patent Application Publication
(10) Pub. No.: US 2015/0026107 A1
(43) Pub. Date: Jan. 22, 2015

(54) SYSTEM AND APPARATUS THAT IDENTIFIES, CAPTURES, CLASSIFIES AND DEPLOYS TRIBAL KNOWLEDGE UNIQUE TO EACH OPERATOR IN A SEMI-AUTOMATED MANUFACTURING SET-UP TO EXECUTE AUTOMATIC TECHNICAL SUPERINTENDING OPERATIONS TO IMPROVE MANUFACTURING SYSTEM PERFORMANCE AND THE METHODS THEREFOR

(71) Applicants: MANUFACTURING SYSTEM INSIGHTS (dba system insights, Berkeley (CA); KENNAMETAL INC., Latrobe, PA (US)

(72) Inventors: Athulan Vijayaraghavan, East Tambaram (IN); William Sobel, Oakland, CA (US); Thomas Owen Muller, Greensburg, PA (US); Adam South, Greensburg, PA (US); Colin Tilzey, Greensburg, PA (US)

(73) Assignees: KENNAMETAL INC., Latrobe, PA (US); MANUFACTURING SYSTEM INSIGHTS (dba system insights, Berkeley, CA (US)

(21) Appl. No.: 14/383,307

(22) PCT Filed: Mar. 18, 2013
(86) PCT No.: PCT/IN2013/000162

§ 371 Date: Sep. 5, 2014

(30) Foreign Application Priority Data
Mar. 18, 2012 (IN) 3571/CHE/2011

(51) Int. Cl. G06N 99/00; G06N 5/04

(52) U.S. Cl. CPC G06N 99/005; G06N 5/04
USPC 706/12

(57) ABSTRACT

A system and method for the capture and storage of industrial process and operational machine data including operator input and environmental factors, the analysis thereof in order to identify elements of tribal knowledge therein, the storage of such elements of tribal knowledge for future reference and analysis and the deployment of such tribal knowledge, specifically in a manufacturing system.

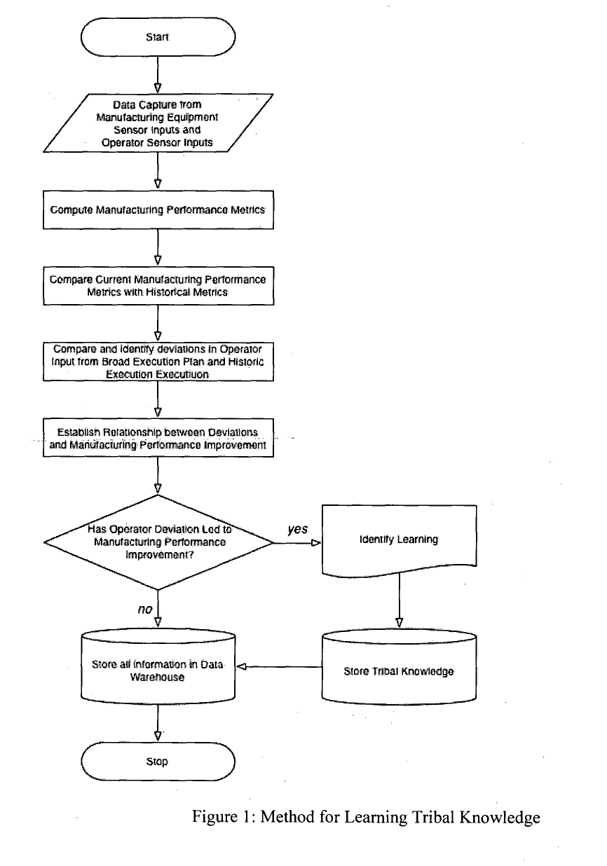

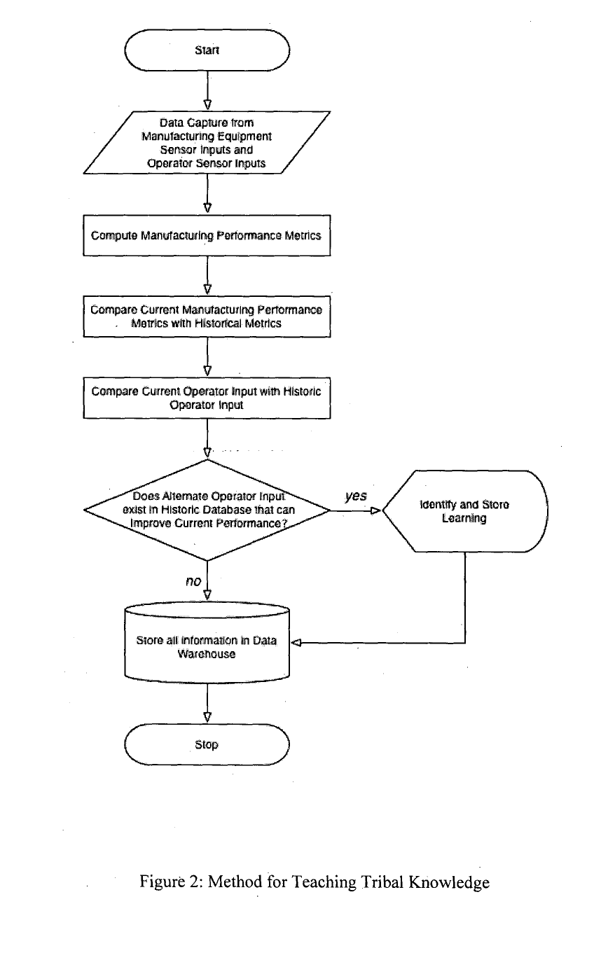

### FIELD OF THE INVENTION

This invention relates to a system and method for the management of inputs from Operators operating within industrial processes, manufacturing systems and the manufacturing equipment comprising a part thereof, and for the collection and analysis of data derived from such inputs. The invention also relates to a system and method that analyses such input data and generates new parameters and instructions for the execution of the process steps relating to that industrial process or manufacturing system. More particularly, the invention relates to a system and method for on-site learning, storing, teaching and training manufacturing process know-how to skilled and semi-skilled operators. The invention also relates to a system and method for providing manufacturing process know-how to any person who may require it at any point.

The invention is addressed to the field of industrial processes and manufacturing systems, where industrial activities-executed by skilled and semi-skilled manufacturing equipment operators are captured, chronicled and analyzed in conjunction with the activities performed by the manufacturing system and status inputs received from the manufacturing system, the manufacturing equipment and the artifact being manufactured. The system comprises the creation of a knowledge-base of operational data relating to manufacturing systems and equipment, operator input, manufacturing performance parameters, artefact data, possible inputs resulting in manufacturing performance improvement in a given situation, analytic operations peformed upon any such data and their relationships, and the deployment of this knowledge to an operator or to any person to improve the performance of the manufacturing system.

A manufacturing system consists of multiple individual heterogenous manufacturing equipment including but not limited to machine tools and manufacturing equipment, metrology devices, sensors, actuators, auxiliary equipment etc. A manufacturing enterprise may comprise one or more manufacturing systems. Manufacturing system performance is determined by attributes including but not limited to: productivity, safety, quality, efficiency and maintenance.

### BACKGROUND AND PROBLEMS WITH THE PRIOR ART

Progressive sophistication and automation in the manufacturing sector calls for skilled operators to operate the manufacturing equipment and execute manual and semi-automated tasks, and they play a vital role in determining the efficiency of a manufacturing enterprise. The ‘skill’ of an operator in executing machine-related tasks (including but not limited to issuing commands to a machine, monitoring machine performance, obtaining desired output quality with optimal utilization of resources, ensuring safety of the machine, its surroundings and the operator/s, taking pro-active action to maintain the machine in good health etc.,) is a combination of acquired knowledge from training and work experience and intuitive insights. The aggregation of such skills of a set of operators in a given industrial processing or manufacturing set-up is referred to as tribal knowledge. In a number of manufacturing systems, the operator is given discretion to modify one or more process steps in the execution of a broad execution plan. With experienced operators, such discretion may be exercised to the benefit of one or more manufacturing performance parameters.

One prominent example of this situation, which by no means is construed as a limitation on the scope of the present invention, is that of high-speed milling. High-speed milling, especially when applied in aerospace or medical device manufacturing, involves manufacturing systems comprising equipment (“machine tools”) and tooling for the manufacture of highly accurate and precise parts in materials that are difficult to work with, like titanium, inconel, and aluminum. Planning the machining process (“process planning”) is a highly specialized task and is generally practiced by a skilled operator in a manufacturing facility. Executing a process plan for high-speed milling requires careful planning and a sound understanding of the milling process. While there are a few standard approaches on how to select the process parameters for a high speed milling operation, operators generally develop the process parameters and make a selection based on their observations of the manufacturing system, and their own knowledge and experience. The operator applies knowledge retained through observation and experience in developing the process plan to create the part. Developing an effective process plan involves selecting the appropriate tooling, and applying them to create the various part features at prescribed process parameters. In high speed milling, these parameters include spindle speed, path feedrate, axis feedrate, surface speed, depth of cut, width of cut, radial engagement, axial engagement, etc. The process parameters are also selected based on the type of machine tool the part is being made on and its capabilities. Thus the same part can be manufactured in a variety of ways using different tools and process parameters, and similarly, the same tool can be operated at different parameters to make a part. However, the knowledge applied by the operator in performing such an operation is highly contextual and incapable of being captured and analysed for future deployment. Additionally, there have been no scientific and reliable methods available in the art to capture, store and retrieve industrial/manufacturing tribal knowledge, particularly tribal knowledge related to manufacturing systems. As a result, hundreds of hours of training imparted by an enterprise to an operator to enhance his skill-level is lost when the operator retires or leaves the enterprise.

Attempts through traditional methods such as videography, interviews/surveys and other documentation have not been successful in capturing tribal knowledge. One significant reason for their failure is the lack of a well-founded system and method to first identify specific tribal knowledge. Even if there are (hypothetical) methods to capture tribal knowledge, there are even fewer methods to store it and make it available when needed. Again, with regard to the specific manufacturing systems surrounding the area of high speed milling, the state of the art involves using one or a combination of the following techniques:
Operator experience
Guidelines/recommendations laid out by manufacturing equipment manufacturer
Guidelines/recommendations laid out by cutting tool manufacturer
Expert systems which are a part of the Computer-Aided Design and/or Computer-Aided Manufacturing software tools/systems.
Using standard handbooks for process parameter selection—Cutting Tool Handbook, Machining Handbook etc.,

The above techniques are very limited in their appeal because:
They are prescriptive, and do not take into account feedback from the actual process execution
They are based on extremely limited lab trials
They do not cover the entire spectrum of processes that are capable on modern manufacturing equipment
They do not take into account differences in the capabilities of different types of manufacturing equipments and cutting tools.

There is therefore a long unfulfilled need for a scientific and reliable system and method to (i) capture and store industrial process and operational machine data including operator input and environmental factors, (ii) analyse such data in order to identify elements of tribal knowledge therein and (iii) deploy such tribal knowledge, especially in a manufacturing system.

The inventors have invented a system and method to (i) capture and store industrial process and operational machine data including operator input and environmental factors, (ii) analyse such data in order to identify elements of tribal knowledge therein and (iii) deploy such tribal knowledge, especially in a manufacturing system. Such a system could be utilized for the purposes of (i) making it available at the right time in the form of training and for analytics and knowledge sharing, and (ii) building a data warehouse of such captured data for the purposes of further analytics.

### OBJECTS OF THE INVENTION

The main object of this invention is to (i) capture and store industrial process and operational machine data including operator input and environmental factors, (ii) analyse such data in order to identify elements of tribal knowledge therein and (iii) deploy such tribal knowledge, especially in an industrial process.

Another object of this invention is to provide for a system that executes technical operations and overrides that boost the efficiency of industrial processes;

Yet another object of this invention is to provide for a chronicled knowledge base of every transformation undergone by the industrial process and/or manufacturing system and the artefacts pertaining thereto from the date of installation, including sequence logs of the causative antecedent factors for every transformation

Yet another object of this invention is to analyse the above-referenced knowledge bases and deploy the knowledge base and analytics derived therefrom in an industrial process and/or manufacturing system.

Yet another object of this invention is to provide for a system that identifies and qualifies specific transformation patterns based on their causal antecedents and classifies them according to their (relative and absolute) resource intensiveness (such as consumption of power, raw material, time, output quality etc.,) and desired parameters that determine its performance;

Another object of this invention is to provide for a system that computes complex cause-effect linear and non-linear relationships of known inputs with other perceptible factors of the industrial processes resulting in realistic and scientific forecasts.

Another object of this invention is to apply the captured tribal knowledge towards the identification of key performance attributes of industrial processes and equipment not envisaged by the manufacturer or the end-user.

Another object of this invention is to provide for real time evaluation and analysis, of an operator's action/input in terms of conformance to/deviation from a given plan.

Another object of this invention is to develop and maintain a warehouse of indexed data starting from the date of installation of this invention on a perpetual basis comprising every transformation including (but not limited to): material removal; rate of material removal; surface properties; mechanical wear; heat conducted, absorbed, dissipated, radiated in unit time; Electric including static charge inducted/discharged; mass; volume; dimensions; artifact quality; vibration in components; process execution capabilities; position, velocity, and acceleration of equipment components and sub-components during process execution; consumption rate of consumables and resources; time lapsed between process steps; order of execution of process steps; commands executed by process equipment.

A further object of this invention is to assess the capability and suitability of operators for a given job work in a manufacturing process and to rank and re-rank them on an ongoing basis either non-intrusively or otherwise, against parameters (including but not limited to) job-protocols; discipline to process compliance; efficiency of resource and consumable consumption; adherence to delivery deadlines; output quality and quantity; material handling efficiency; maintenance and functional life of manufacturing system.

A further object of this invention is to analyse the captured tribal knowledge base in identifying the type of knowledge to be communicated to an operator based on assessing the immediate needs of the operator. A further object of this invention is to communicate such identified tribal knowledge to the operator using an appropriate communications interface in real-time.

A further object of this invention is to develop a knowledge database of accumulated tribal knowledge for future reference and analysis by an operator or other person.

A further object of this invention is to analyse a database of performance attributes of a given manufacturing system, component within an manufacturing system or combination of manufacturing systems in order to provide analytics of use to any person interested in the maintenance, operation or optimization towards improvement of manufacturing performance parameters of such manufacturing systems or steps or components thereof.

### STATEMENT AND SUMMARY OF THE INVENTION

According to this invention there is therefore provided a system, and method to enable data capture in an industrial process, analysis of such captured data for the purposes of tribal knowledge identification and deployment of such tribal knowledge.

The system consists of the following elements:
i. Data Capture Means including manufacturing system sensor inputs to read and capture operational data from manufacturing equipment during the execution of a process step and the metrology equipment comprising a part thereof, and from the actions of the operator and relevant environmental factors. Optionally, independent metrology equipment with interfaces for transmitting information between the manufacturing system and the system may be included in the system where the manufacturing system does not possess the metrology equipment to interface with the system.
ii. Means, including operator input sensors, for the capture of input from a manufacturing equipment operator
iii. Means for communicating information, including the broad execution plan to the operator
iv. Input interfaces for operator to send input signals (keyboards, touchscreen, buttons etc.,)
v. A data collection unit for the collection of captured data storage of transmitted data
vi. A data transmission unit for the transmission of such collected data
vii. A server for the collection of such transmitted data
viii. A data storage unit for the short term storage of such transmitted data
ix. A historical data repository for the long term storage of the transmitted data and corresponding operational data parameters as well as historical data transmitted from previous manufacturing equipment executions and corresponding manufacturing performance parameters
x. An analysis unit for the purpose of determining the manufacturing performance parameters based on the transmitted data and converting the same into processed information
xi. An evaluation unit located on the server for the comparison of such transmitted data against corresponding historical data in the historical data repository
xii. A first logic unit located on the server for the determination of deviations in operator input data from corresponding historical data relating to the same or similar manufacturing equipment and/or from the broad execution plan
xiii. A second logic unit located on the server for the determination of deviations in operational data and artifact data from corresponding historical data relating to the same or similar manufacturing equipment and/or from the specifications of the broad execution plan
xiv. A third logic unit located on the server for the identification and analysis of relationships between determined deviations in operator input data and determined deviations in in operational data and artifact data
xv. A learning unit located on the server for the determination of improvements in operational parameters of the manufacturing equipment, manufacturing performance parameters and/or the artifact based on the relationships determined by the third logic unit
xvi. A fourth logic unit located on the server for the comparison of operator input data against historical operator input data relating to the same or similar manufacturing equipment that has resulted in improvements in operational parameters of the manufacturing equipment, manufacturing performance parameters and/or the artifact
xvii. A fifth logic unit located on the server for the determination of alternative operator inputs that would result in improvements in the parameters relating to manufacturing performance.
xviii. A teaching unit located on the server for the creation of recommendations corresponding to alternative operator inputs that would result in improvements in the parameters relating to manufacturing performance.
xix. A second data storage unit located on the server for the storage of such determined improvements in operational parameters of the manufacturing equipment, manufacturing performance parameters and/or the artifact along with all transmitted data at the time of operation of the manufacturing equipment as well as such recommendations corresponding to alternative operator inputs that would result in improvements in the parameters relating to manufacturing performance.
xx. A data transmission unit for the transmission of such recommendations corresponding to alternative operator inputs that would result in improvements in the manufacturing performance parameters to the manufacturing equipment operator or any other person, whether in real time or at any subsequent point.

The method by which the system captures data for a given iteration of a operation, analyses the captured data for the purpose of tribal knowledge identification and deploys the data is described as follows:
1. The Method by which the system captures data is as follows:
   a. The operator inputs commands into the manufacturing equipment
   b. The data collecting unit collects operational data from the manufacturing equipment sensor inputs, data inputted by the manufacturing equipment operator from the operator sensor inputs, data retrieved from the metrology equipment relating to the artifact being processed and data relating to the broad execution plan;
   c. The operator inputs commands using the input interface of the metrology equipment to measure the artifact once it is processed; Alternatively, the manufacturing equipment sensor inputs monitors the quality of the part through interfaces with the metrology equipment;
   d. Process execution/measurement data is stored in a data storage unit located in a local server, and then transmitted through a first data transmission unit on to historical data repository located on a remote server for long term archival/retrieval.
   e. The historical data repository stores all data concerning the manufacturing system, the operator's input, data relating to relevant environmental factors and data concerning the processed artifact
2. The Method by which the system analyses data for the purposes of identifying tribal information is as follows:
   a. The analysis unit retrieves the stored data relating to the given iteration of the operation from the historical data repository, computes manufacturing performance metrics including productivity, efficiency, utilization, quality, rejection parts per million (PPM) etc., and stores them along with the other data
   b. The analysis unit analyses data in order to produce information relating to the operator as follows:
      i. The analysis unit analyses operator input in the course of the execution of the broad execution plan
      ii. The analysis unit computes manufacturing performance metrics including productivity, efficiency, utilization, quality, rejection PPM etc., and stores them along with the other data
      iii. The evaluation unit compares such operator input against corresponding historical data in a historical data repository
      iv. The first logic unit makes determinations of deviations (if any) in the operator's input from corresponding historical data relating to the same or similar manufacturing equipment and/or from the broad execution plan;
      v. the second logic unit determines deviations in operational data and artifact data from corresponding historical data relating to the same or similar manufacturing equipment and/or from the specifications of the broad execution plan
      vi. third logic unit identifies and analyses relationships between the determined deviations in operator input data against determined deviations in in operational data and artifact data
      vii. The learning unit determines improvements in operational parameters of the manufacturing, equipment, manufacturing performance parameters and/or the artifact based on the relationships determined by the third logic unit
      viii. Such determined improvements are stored in long term memory by a second storage unit which may also be the historical data repository
      ix. The fourth logic unit then compares such operator input data against historical operator input data relating to the same or similar manufacturing equipment that has resulted in improvements in operational parameters of the manufacturing equipment, manufacturing performance parameters and/or the artefact
      x. The fifth logic unit then determines alternative operator inputs that would result in improvements in the operational parameters of the manufacturing equipment and/or the artefact
      xi. The teaching unit then creates recommendations corresponding to alternative operator inputs that would result in improvements in the operational parameters of the manufacturing equipment and/or the artefact;
      xii. the second data storage unit stores such recommendations
      xiii. Such recommendations may then be transmitted to the machine equipment operator or to or any other person, whether in real time or at any subsequent point

### DETAILED DESCRIPTION OF THE INVENTION

The invention provides for a system of data collection, data analysis and tribal knowledge identification, and deployment of tribal knowledge in a manufacturing system. The invention includes the system, devices, apparatus and methods of the invention. The invention relates to the management of manufacturing system sensor inputs according to instructions sent by the system. The system collects and analyses including operational machine data, inputs from the operator unit and environmental factors. The analysis of the collected data allows the system to generate new parameters and instructions for the execution of the broad execution plan.

The invention seeks to perform certain steps within ‘real-time’. For the purposes of this invention, the delineation of time and process intervals and the explanation of the term ‘real-time’ is as follows:

The broad execution plan is a list of instruction that lays out the prescribed process steps for performing one or a series of transformations upon an artifact. The broad execution plan may be reduced into a recorded medium, such as paper or instructions on a visual display unit, orally instructed to the operator or merely internalized within the operator's memory. The broad execution plan is divided into a number of process steps or operations. The operator has the discretion to modify the manner in which a process step is performed as well as to alter their sequence, dispense with certain process steps and/or add new process steps within the broad execution plan.

A process step is a defined task that a machine tool, system or operator has to perform in order to work a transformation upon an artefact.

A function is said to be performed by the invention or any part thereof in real-time when the said function is performed before the commencement of the process step subsequent to the one for which data pertaining to that function has been collected.

The manufacturing system sensor inputs capture operational data through inputs from devices such as computerised numeric controller (CNC), numeric controller (NC) and programmable logic controller (PLC) accelerometers, gyroscopes, thermistors, thermocouples, vibration sensors, optical gauges, eddy current sensors, capacitive sensors, power meters and energy meters.

The operational data to be captured by the system includes data relating to all or any of the following operational parameters: acceleration, vibration, temperature, position, energy usage, current drawn, voltage, power factor, magnetic field, distance, position, capacitance; and data reported by a CNC and/or PLC controller including: axes positions, axes feedrate, surface speed, path feedrate, axes acceleration, axes jerk, spindle speed, axis loads, spindle loads, program block being executed, program line being executed, current macro variables in CNC memory, alarms, messages, other notifications.

The environmental factors that may be captured include date, time, manufacturing system characteristics (such as age, make, model, etc), Maintenance status, Operator status, and state of operation.

The artefact is a physical object that is transformed by the manufacturing system.

The system provides for operator sensor inputs that capture data inputted by a manufacturing equipment operator over the course of the execution of the manufacturing equipment operation.

The metrology equipment used for the capture of data by the system includes gage blocks, coordinate measurement machines (stationary and portable), go/no-go gages, capacitance probes, laser-based systems, interferometry, microscopy, profilometry, air gages, LVDT probes and articulating arms.

The broad execution plan is communicated to the operator using appropriate means before the commencement of the operation. Such means may include video display units, audio players, written instructions and oral instructions. The operator is made aware of the overall method of the operation of the manufacturing equipment.

The display unit of the system used to communicate instructions to the operator includes video monitors, video screens and the like.

The operator inputs commands to the machine tool using an input interface which may include keyboards, touch screens and buttons.

The data collection unit collects the data from the operation of the manufacturing equipment. The collected data includes operational data from the manufacturing equipment sensor inputs, data inputs from the manufacturing equipment operator retrieved from the operator sensor outputs, data relating to the artefact retrieved from the metrology equipment and data relating to the broad execution plan. The data collected by the data collection unit is transmitted via a first data transmission unit. The collected data transmitted through the first data transmission unit is then sent to a server. The transmitted data is stored on a first data storage unit located on the server. This storage unit is intended for short term storage. The analysis unit is located on the server. The analysis unit is a specific set of programs that performs retrieval and selects operational parameters from the captured data. The operational parameters selected are manufacturing performance parameters including productivity, efficiency, utilization, failure rate, rejection rate, first-time quality, overall equipment effectiveness, operating cost, product cost, production efficiency, rejection rate, rejection rate parts per million, rework rate, availability, in-cycle time, cycle time, available time, repair time, planned downtime, unplanned downtime, total downtime. The long term storage of the transmitted data is achieved by means of a second data storage unit, which may also be the historical data repository unit located on the server. In addition to the transmitted data, the historical data repository unit also contain:
a. manufacturing performance parameters based on such transmitted operational data
b. historical data transmitted from previous manufacturing equipment executions and corresponding manufacturing performance parameters
c. determined deviations in operator input data from corresponding historical data relating to the same
d. determined deviations in operational data and artifact data from corresponding historical data and/or from the specifications of the broad execution plan
e. relationships between determined deviations in operator input data and determined deviations in in operational data and artifact data
f. improvements in operational parameters of the manufacturing equipment, manufacturing performance parameters and/or the artefact
g. alternative operator inputs that would result in improvements in the parameters relating to manufacturing performance
h. recommendations corresponding to alternative operator inputs that would result in improvements in the parameters relating to manufacturing performance.

The evaluation unit located on the server compares the operational parameters selected by the analysis unit such as operational data, operator input data and artifact data against the corresponding historical data stored in the historical data repository. The first logic unit is located on the server. The first logic unit determines whether the operator input of the transmitted data deviates from the corresponding historical data of the same or similar machine tool and the broad execution plan. The second logic unit is also located on the server. The second logic unit determines whether the operational data and artefact data of the transmitted data deviate from the corresponding historical data of the same or similar machine tool and the broad execution plan. A third logic unit, also located on the server, determines relationships between the deviations determined from operator input and deviations determined from the operational data and artefact data. The learning unit is located on the server and determines whether the relationships so determined by the third logic unit result in improvements in operational parameters of the manufacturing tool, manufacturing performance parameters and/or the artifact. The fourth logic unit, also located on the server, compares operator input data against historical operator data. The compared sets of data pertain to data from the same or similar manufacturing tool that has resulted in improvements in operational parameters of the machine tool, manufacturing performance parameters and/or the artefact. The fifth logic unit present on the server determines the alternative operator inputs that would result in improvements in the manufacturing performance parameters. The teaching unit is also located on the server. The teaching unit creates recommendations based on alternative operator inputs that would improve the parameters relating to manufacturing performance. The second data storage unit located on the server stores the improvements determined by the logic unit. These determinations relate to improvements in operational parameters of the machine tool, manufacturing performance parameters and/or the artefact including the transmitted data at the time of operation of the machine tool. The second storage data unit also stores the recommendations which correspond to improvements in manufacturing performance parameters achieved as a result of alternative operator input. The system includes a second data transmission unit to transmit the recommendations regarding alternative operator inputs to machine tool operator or any other person. The recommendations are designed to result in improvements in the manufacturing performance parameters.

In addition to the above, there may be an embodiment where the server is remotely located in relation to the location of the manufacturing system. The remotely located server is located in a different location and is not within the physical proximity of the manufacturing system.

There may also be an embodiment in which the second data storage unit is the same as the historical data repository unit.

The transmission of recommendations from the second data transmission unit as mentioned above can be made to one or a plurality of persons including the machine tool operator. The machine tool operators receive the recommendations in real time so that they may be applied during the course of the execution of the machine tool operation.

The method by which data collection, data analysis and tribal knowledge identification, and deployment of such tribal knowledge is implemented is by first collecting operational data from the manufacturing system sensor inputs, machine tool operator, metrology equipment and the broad execution plan. The collected data is then transmitted through a first data transmission unit to the server. The data is then stored in the first data storage unit. The transmitted data is then analysed by the analysis unit which determines the manufacturing performance parameters for manufacturing the artefact. The data culled by the analysis unit includes any deviations in operational parameters owing to alternative operator input. The transmitted data is then compared with historical data by the evaluation unit. The evaluation unit compares the operational data, operator input data and artefact data of the transmitted data against corresponding historical data already present in the historical data repository. The evaluation unit detects variations in transmitted data as against historical data. The first logic unit then detects deviations in the operator input data. This determination is arrived at by comparison with the corresponding historical data relating to the same or similar manufacturing tool. The deviation is also determined using the broad execution plan. A second logic unit then determines deviations in operational data and artefact data. This determination is arrived at by comparison with the corresponding historical data relating to the same or similar manufacturing tool. A third logic unit then identifies and analyses relationships between determined deviations in operator input data against determined deviations in operational data and artefact data. A learning unit then determines improvements in operational parameters of the machine tool, manufacturing performance and/or the artefact. The learning unit determines these improvements through the relationships determined by the above-mentioned third logic unit. The learning unit stores the improvements in operational parameters for use in subsequent execution plans. A second storage data unit then stores the transmitted data captured at the time of operation and the determined data. The determined data includes improvements in operational parameters of the machine tool, manufacturing performance and/or the artefact. A fourth logic unit is used for the comparison of data inputs made by the operator against previously made historical operator input data. The compared data inputs pertain to the same or similar machine tool where the data inputs resulted in improvements in operational parameters of the machine tool, manufacturing performance and/or the artefact. A fifth logic unit determines whether alternative operator inputs such as deviations from the broad execution plan, i.e., tribal knowledge, would result in improvements in the operational parameters of the machine tool and/or the artefact. The teaching unit is used in the dispensation of the collected tribal knowledge to other operators. The teaching unit makes recommendations to the operators, regarding alternative operator inputs that would improve the operational parameters of the machine tool and/or artefact. The above mentioned recommendations generated by the teaching unit are stored in the previously disclosed second data storage unit. The recommendations generated by the teaching unit are then transmitted to the machine tool operator in real time. The fifteenth aspect of the invention relates to the means by which the data collecting unit collects the operational data from the manufacturing system sensor inputs, the data inputted in the operator sensor units by the machine tool operator, the data about the artefact produced that is retrieved from the metrology equipment and the data pertaining to the broad execution plan. The data collection unit operates in real time. In one aspect of the invention, the server referred to is remotely located in relation to the location of the manufacturing system and is not within the physical proximity of the manufacturing system. In another aspect of the invention, the second data storage unit is the same as the historical data repository unit mentioned above. A further aspect of the invention provides for the transmission of recommendations made by the afore-mentioned learning unit to multiple persons. The learning unit transmits the recommendations based on alternative operator input to the machine tool operator or to any other person so that they may also achieve improvements in the operational parameters of the machine tool and/or the artefact. Another aspect of the invention relates to the transmission of the recommendations in real time. The machine tool operators receive the recommendations in real time so that they may be applied during the course of the execution of the machine equipment process step.

### Working Embodiment

The following working embodiment illustrates the use of the invention in the context of a specific manufacturing system, involving high speed milling. The steps by which operational data is collected, processed for identifying tribal knowledge and deployed along with relevant algorithms within the manufacturing system are outlined below:

A. Data Collection
1. The operator steps up to a personal computer next to a 5-axis high speed milling machine tool (‘the machine tool’) and loads the broad process plan on the machine tool in a format generated by a computer assisted modelling software as is generally available in the market such as CAM
2. The operator loads a titanium workpiece into the machine tool
3. The operator enters the process steps into the user interface that he has opened on the computer next to the machine tool
4. The operator enters appropriate meta-data into the user interface including:
   a. workpiece material
   b. cutting tool make, model, type
   c. expected cycle time for operation
   d. planned path feedrate
   e. planned spindle speed
   f. expected part quality measurement
5. The operator confirms the program settings and starts the machining process
6. Real-time data is collected from the machine tool pertaining to:
   a. acoustics
   b. vibration
   c. power consumption
   d. path feedrate
   e. axes loads
   f. spindle loads
   g. alarms
   h. conditions
   i. program block and line
   j. path position
   k. axes position
   l. macro variables
7. The server specifically captures the operator changing the Feedrate Override on the machine tool to 125% just at the start of machining
8. This data is transmitted in real-time to the local processing system and then transmitted to the remote server
9. The remote server monitors all the transmitted data and waits until the program is completed and the part is unclamped from the machine tool
10. The operator indicates that the part has finished machining, and measures key parameters in a nearby metrology system
11. The metrology data is also captured and transmitted to the local server and the remote server

### Data Processing and Traditional Knowledge Identification

1. Once all this information is received, the remote server calculates the following metrics:
   a. average pathfeedrate=100 inches/minute
   b. actual process time/planned process time=80%
   c. actual quality/planned quality=100%
   d. average spindlespeed=6000 rpm
   e. average power drawn=5 kw
   f. average vibration=0.1 g
2. The remote server compares all of these parameters with other cases of 5-axis machining using the same cutting tool on the same type of machine tool on the same workpiece material from all available historical data (“community” data)
   a. community data pathfeedrate: 80 inches/minute
   b. average power drawn: 8 kw
   c. average actual/planned process time=120%
3. Based on the above values, it marks the operator action of changing the Feedrate

Override on the machine tool to 125% just at the start of machining as tribal knowledge

A sample algorithm is provided below to illustrate the calculation of manufacturing performance parameters for Cycle Time and Average Path Feedrate

ALGORITHM - CALCULATE AVERAGE
PATHFEEDRATE OF PART

input:
- vector V of all PathFeedrate observations from a machine tool m
till current time T_now, indexed by timestamp
- time T_start when machine started operating on part p
- time T_end when machine completed operating on part p
output:
- average-pathfeedrate f
Steps:
- extract subset v from V such that v contains observations
between T_start and T_end
- f = mean(v)
- return f

A sample algorithm is provided below to illustrate the comparison of transmitted operational data with historical data and the marking of such data as tribal knowledge

ALGORITHM - COMPARE-WITH-COMMUNITY-DATA-
AND-MARK-AS-TRIBAL-KNOWLEDGE

```
input:
- set D of all temporally indexed data from community. D consists
of multiple temporally indexed vectors d1 . . . dN each pertaining to
one type observation from the community
- search criteria s, specifying [machine-tool-type, cutting-tool-type,
workpiece-type]
- set P of all temporally indexed data from the process being monitored.
P consists of multiple temporally indexed vectors p1 . . . pN each
pertaining to one type observation from the community
output:
- boolean variable isImproved
- boolean variable recordastribalknowledge
Steps:
- for each vector di in D:
  - compute performance measure dm_i
- end
- for each vector pi in in P:
  - compute performance measure pm_i
- end
- if Count(pm_i > dm_i) for all i > N/2
  - return {isImproved = TRUE and recordastribalknowledge =
TRUE }
- else return {isImproved = FALSE and recordastribalknowledge =
FALSE}
- end
```

### Tribal Knowledge Deployment

1. The operator steps up to a personal computer next to a 5-axis high speed milling machine tool (‘the machine tool’) and loads the broad process plan on the machine tool in a format generated by a computer assisted modelling software as is generally available in the market such as CAM
2. The operator loads a titanium workpiece into the machine tool
3. The operator enters the process steps into the user interface that he has opened on the computer next to the machine tool
4. The operator enters appropriate meta data into the user interface including:
   a. workpiece material
   b. cutting tool make, model, type
   c. expected cycle time for operation
   d. planned path feedrate
   e. planned spindle speed
   f. expected part quality measurement
5. The operator confirms the program settings and starts the machining process
6. Realtime data is collected from the machine tool pertaining to:
   g. Acoustics
   h. vibration
   i. power consumption
   j. path feedrate
   k. axes loads
   l. spindle loads
   m. alarms
   n. conditions
   o. program block and line
   p. path position
   q. axes position
   r. macro variables
7. This data is transmitted in realtime to the local processing system and then transmitted to the remote server
8. Based on the user interface data and the realtime data streaming from the machine, the remote server determines:
   s. planned pathfeedrate is 50 inches/min
   t. machine is running at 100% feedrate override
   u. current feedrate on machine tool is 50 inches/minute
9. It compares all of these parameters with other cases of 5-axis machining using the same cutting tool on the same type of machine tool on the same workpiece material from all available historical data (“community” data) and identifies pertinent tribal knowledge: “On a ABC 5-axis machine tool using a XYZ solid-carbide endmill and a titanium workpiece, the machining process can take place at a feedrate of 100 inches/minute without any adverse negative effects”
10. The remote server additionally analyzes the realtime parameters on the machine tool and identifies that the Feedrate Override of 100% can be increased to 200% such that a feedrate of 100 inches/minute can be achieved, without harming the operator or affecting his/her safety in any way
11. The remote server sends a message to the visual display unit saying: Please Increase PathFeedrate to 100 inches/minute by setting Feedrate Override at 200%. This will increase your productivity by 100%.

A sample algorithm is provided below to illustrate the identification of tribal knowledge and the teaching of the same to the Operator.

ALGORITHM: IDENTIFYING AND TEACH OPERATOR

```
input:
- set D of all temporally indexed data from community. D consists of
multiple temporally indexed vectors d1 . . . dN each pertaining to one
type observation from the community
- search criteria s, specifying [machine-tool-type, cutting-tool-type,
workpiece-type], which pertains to the current conditions of the
manufacturing process being monitored and for which recommendations
are being sought
- set P of all temporally indexed data from the process being monitored.
P consists of multiple temporally indexed vectors p1 . . . pN each
pertaining to one type observation from the community
output:
- variable recommendation Parameters
Steps:
- filter D such that it only contains observations from the community
that match search criteria s
- for each vector di in D:
- compute performance measure dm_i
  - compute bi pertaining to the case with best performance, max(dm_i)
- end
- for each vector pi in P:
  - if (bi > pi) then copy dm_i corresponding to bi into array R
- end
- if length(R) > 0
  - return(R)
- else return(0)
- end
```

1-18. (canceled)

19. A system for data collection, data analysis and tribal knowledge identification, and deployment of tribal knowledge in a manufacturing system comprising:
a plurality of sensor inputs for the capture of data from the manufacturing system in the course of execution of an operation upon an artefact by an operator in accordance with a broad execution plan;
a data collection unit for collecting the data;
a first data transmission unit for the transmission of the collected data;
a server for receiving and collecting the data transmitted from the first data transmission unit;
a data storage unit located on the server;
an analysis unit located on the server for the determination of manufacturing performance parameters based on the transmitted data;
a historical data repository unit located on the server for the long term storage of the transmitted data and corresponding operational data parameters as well as historical data transmitted from previous manufacturing system executions and corresponding manufacturing performance parameters, including one or more of: historical operational data, historical operator input data and historical artefact data;
an evaluation unit located on the server for comparison of the transmitted data against corresponding historical data in the historical data repository
a logic unit located on the server for the determination of deviations in the data from corresponding historical data relating to the same or similar manufacturing system and/or from the broad execution plan and for the creation of one or more recommendations corresponding to alternative operational data that would result in improvements in the parameters relating to manufacturing performance; and
a second data transmission unit for the transmission of the one or more recommendations corresponding to alternative operational data that would result in improvements in the manufacturing performance parameters.

20. The system of claim 19 wherein the plurality of sensor inputs comprises one or more of:
manufacturing system sensor inputs for the capture of operational data from the manufacturing system in the course of the execution of the operation upon the artefact;
operator sensor inputs for the capture of data inputted by the operator; and
metrology equipment for the capture of data relating to the artefact being processed by the manufacturing system.

21. The system of claim 20 wherein the data comprises one or more of:
operational data from the manufacturing equipment sensor inputs;
data inputted by the operator from the operator sensor inputs; and
data retrieved from the metrology equipment relating to the artefact being processed and data relating to the broad execution plan.

22. The system of claim 19 further comprising a display unit for the communication of information to the operator.

23. The system of claim 19 further comprising an input interface for the operator to input commands to the manufacturing equipment.

24. The system of claim 19 wherein the data storage unit comprises one or more of:
a first data storage unit located on the server for the short term storage of the transmitted data from the first data transmission unit; and
a second data storage unit located on the server for the storage of such determined improvements in operational parameters of the manufacturing equipment, manufacturing performance parameters and/or the artefact along with all transmitted data at the time of operation of the manufacturing equipment as well as such recommendations corresponding to alternative operator inputs that would result in improvements in the parameters relating to manufacturing performance.

25. The system of claim 21 wherein the logic unit comprises one or more of:
a first logic unit for the determination of deviations in operator input data from corresponding historical data relating to the same or similar manufacturing equipment and/or from the broad execution plan;
a second logic unit located on the server for the determination of deviations in operational data and artefact data from corresponding historical data relating to the same or similar manufacturing equipment and/or from the specifications of the broad execution plan;
a third logic unit located on the server for the identification and analysis of relationships between determined deviations in operator input data and determined deviations in operational data and artefact data;
a learning unit located on the server for the determination of improvements in one or more operational parameters of the manufacturing equipment, manufacturing performance parameters and/or the artefact based on the relationships determined by the third logic unit;
a fourth logic unit located on the server for the comparison of operator input data against historical operator input data relating to the same or similar manufacturing equipment that has resulted in improvements in operational parameters of the manufacturing equipment, manufacturing performance parameters and/or the artefact; and
a fifth logic unit located on the server for the determination of alternative operator inputs that would result in improvements in the parameters relating to manufacturing performance.
a teaching unit located on the server for the creation of recommendations corresponding to alternative operator inputs that would result in improvements in the parameters relating to manufacturing performance.

26. The system of claim 20 wherein the manufacturing system sensor inputs comprise one or more of: a computerized numeric controller (CNC); a numeric controller (NC) and programmable logic controller (PLC); an accelerometer; a gyroscope; a thermistor; a thermocouple; a vibration sensor; an optical gauge; an eddy current sensor; a capacitive sensor; a power meter; an energy meter; a current meter; a voltage meter; an analog-to-digital sensor; and a digital sensor.

27. The system of claim 21 wherein the operational data comprises data relating to one or more of the following operational parameters: acceleration, vibration, temperature, position, energy usage, current drawn, voltage, power factor, magnetic field, distance, position, capacitance, and data reported by a CNC and/or PLC controller comprising one or more of: axes positions, axes feedrate, surface speed, path feedrate, axes acceleration, axes jerk, spindle speed, axis loads, spindle loads, program block being executed, program line being executed, current macro variables in CNC memory, alarms, messages, and other notifications.

28. The system of claim 20 wherein the metrology equipment comprises one or more of the following instruments: a gage block, a coordinate measurement machine, a go/no-go gage, a capacitance probe, a laser-based system, an air gage, a linear variable differential transformer probe, an articulating arm an interferometry device, a microscopy device, and a profilometry device.

29. The system of claim 19 wherein the server is a remote server located at a different location from the manufacturing system.

30. The system of claim 19 wherein the manufacturing performance parameters comprise one or more of the following parameters: productivity, efficiency, utilization, failure rate, rejection rate, first-time quality, overall equipment effectiveness, operating cost, product cost, production efficiency, rejection rate, rejection rate parts per million, rework rate, availability, in-cycle time, cycle time, available time, repair time, planned downtime, unplanned downtime, and total downtime.

31. The system of claim 19 wherein the historical data repository unit and the data storage unit are the same unit.

32. The system of claim 19 wherein the historical data repository comprises a data warehouse that performs one or more of the following functions:
long term storage of all data transmitted during a given process step and/or broad execution plan;
long term storage of all determined improvements in operational parameters of the manufacturing equipment, manufacturing performance parameters and/or the artefact;
long term storage of all recommendations corresponding to alternative operator inputs that would result in improvements in the parameters relating to manufacturing performance;
long term storage of all analytic operations performed upon such stored data;
long term storage of all data and resulting information collected by the system as claimed in claim 1.

33. The system of claim 19 wherein the one or more recommendations are transmitted to the manufacturing equipment operator or any other person in real time during the course of execution of the manufacturing equipment operation.

34. The system of claim 19 wherein the second data transmission unit is capable of transmitting at least one of the following to any person at any point of time:
operational data from the manufacturing equipment sensor inputs, data inputted by the manufacturing equipment operator from the operator sensor inputs, data retrieved from the metrology equipment relating to the artefact being processed and data relating to the broad execution plan;
manufacturing performance parameters based on such transmitted operational data;
historical data transmitted from previous manufacturing equipment executions and corresponding manufacturing performance parameters;
determined deviations in operator input data from corresponding historical data relating to the same;
determined deviations in operational data and artefact data from corresponding historical data and/or from the specifications of the broad execution plan;
relationships between determined deviations in operator input data and determined deviations in in operational data and artefact data;
improvements in operational parameters of the manufacturing equipment, manufacturing performance parameters and/or the artefact;
alternative operator inputs that would result in improvements in the parameters relating to manufacturing performance; and
recommendations corresponding to alternative operator inputs that would result in improvements in the parameters relating to manufacturing performance.

35. A method of data collection, analysis and tribal knowledge identification, and deployment of tribal knowledge in a manufacturing system, the method comprising:
collecting data by means of a data collection unit;
transmitting, by means of a first data transmission unit, the collected data to a server;
storing the transmitted data on a data storage unit;
analyzing the transmitted data, by means of an analysis unit, for the determination of manufacturing performance parameters based on the transmitted data;
comparing, by means of an evaluation unit, the transmitted data against corresponding historical data in a historical data repository
determining deviations in the data from corresponding historical data relating to the same or similar manufacturing system and/or from the broad execution plan and for the creation of one or more recommendations corresponding to alternative operator inputs that would result in improvements in the parameters relating to manufacturing performance; and
transmitting the one or more recommendations to the manufacturing system and/or an output device.

36. The method of claim 35 wherein collecting data comprises collecting one or more of:
operational data from manufacturing system sensor inputs;
data inputted by an operator from operator sensor inputs;
data retrieved from metrology equipment relating to an artefact being processed; and
data relating to a broad execution plan

37. The method of claim 36 wherein determining deviations in the data comprises:
determining, by means of a first logic unit, deviations in operator input data from corresponding historical data relating to the same or similar manufacturing equipment and/or from the broad execution plan;
determining, by means of a second logic unit, deviations in operational data and artefact data from corresponding historical data relating to the same or a similar manufacturing system and/or from specifications of the broad execution plan;
identifying and analyzing relationships, by means of a third logic unit, between the determined deviations in operator input data against determined deviations in operational data and artefact data;
determining, by means of a learning unit, improvements in operational parameters of the manufacturing system, manufacturing performance parameters and/or the artefact based on the relationships determined by the third logic unit;
storing, by means of a second data storage unit, of the determined improvements in operational parameters of the manufacturing system, manufacturing performance parameters and/or the artefact along with all transmitted data at the time of operation of the manufacturing system;
comparing, by means of a fourth logic unit, operator input data against historical operator input data relating to the same or similar manufacturing equipment that has resulted in improvements in operational parameters of the manufacturing equipment, manufacturing performance parameters and/or the artefact;
determining, by means of a fifth logic unit, alternative operator inputs that would result in improvements in the operational parameters of the manufacturing equipment and/or the artefact;
creating recommendations corresponding to alternative operator inputs that would result in improvements in the operational parameters of the manufacturing equipment and/or the artefact, by means of the teaching unit; and
storing, by means of the second data storage unit, the recommendations corresponding to alternative operator inputs that would result in improvements in the operational parameters of the manufacturing system and/or the artefact.

38. The method of claim 35 wherein collecting data by means of a data collection unit is conducted in real time during the course of execution of the manufacturing system operation.

39. The method of claim 35 wherein the recommendations are transmitted to the manufacturing equipment operator or any other person in real time during the course of execution of the manufacturing system operation.

40. The method of claim 36 where at least one of the following may be transmitted to any person at any point of time:
operational data from the manufacturing equipment sensor inputs;
data inputted by the manufacturing equipment operator from the operator sensor inputs, data retrieved from the metrology equipment relating to the artefact being processed and data relating to the broad execution plan;
manufacturing performance parameters based on the transmitted operational data;
historical data transmitted from previous manufacturing equipment executions and corresponding manufacturing performance parameters;
determined deviations in operator input data from corresponding historical data relating to the same;
determined deviations in operational data and artefact data from corresponding historical data and/or from the specifications of the broad execution plan;
relationships between determined deviations in operator input data and determined deviations in in operational data and artefact data;
improvements in operational parameters of the manufacturing equipment, manufacturing performance parameters and/or the artefact;
alternative operator inputs that would result in improvements in the parameters relating to manufacturing performance; and
recommendations corresponding to alternative operator inputs that would result in improvements in the parameters relating to manufacturing performance.

41. A method of providing one or more improved process parameters for a particular manufacturing operation, the method comprising:
receiving, on a server, data associated with a plurality of manufacturing operations;
storing the received data as historical data in a data storage unit on the server;
receiving other data related to the particular manufacturing operation, the other data including an indication of a particular tool being used in the particular machining operation;
determining, from among the historical data, the one or more improved process parameters for the particular manufacturing operation based on the other data received and at least one manufacturing performance parameter; and
providing an indication of the one or more improved process parameters of the particular manufacturing operation.

42. A system for providing a user with one or more improved process parameters for a particular manufacturing operation defined by data specified by a user, the system comprising:
an electronic database;
a processing device adapted to receive data from manufacturing operations performed on one or more manufacturing systems via an electronic network and store and retrieve the data as historical data in the electronic database; and
an interface device in electronic communication with the processing device, the interface device adapted to communicate the data specified by the user,
wherein the processing device is adapted to:
determine, from among the historical data, the improved process parameters for the particular machining operation based on the data specified by the user and at least one manufacturing performance parameter; and
provide an indication of the one or more improved manufacturing parameters to the user.

43. The system of claim 42 further comprising one or more sensors disposed on each manufacturing system, wherein each of the sensors is structured to detect and communicate data from manufacturing operations performed on the manufacturing system.

44. The system of claim 42 further comprising a display in communication with the processing device, wherein the display is adapted to provide a visual indication of the one or more improved process parameters to the user.
